(19) United States
(12) Patent Application Publication
(10) Pub. No.: US 2026/0174141 A1
(43) Pub. Date: Jun. 25, 2026

(54) AEROSOL PROVISION DEVICE

(71) Applicant: Nicoventures Trading Limited, London (GB)

(72) Inventor: Theodora NANNOU, London (GB)

(21) Appl. No.: 19/125,603

(22) PCT Filed: Oct. 24, 2023
(86) PCT No.: PCT/EP2023/079643

§ 371 Date: Apr. 29, 2025

(30) Foreign Application Priority Data
Oct. 31, 2022 (GB) 2216090.7

(51) Int. Cl. A24F 40/46; A24F 40/20; H05B 3/22

(52) U.S. Cl. CPC A24F 40/46; H05B 3/22; A24F 40/20

(57) ABSTRACT

An aerosol provision device is provided. The aerosol provision device is configured to heat at least part of an article comprising aerosol generating material. The aerosol provision device comprises a receptacle for receiving at least a portion of the article. The receptacle comprising a reflecting surface arranged to reflect electromagnetic radiation towards the article. The reflecting surface has a minimum reflectivity of electromagnetic radiation with a wavelength between 1000 nm and 700 nm of at least 60%.

### CROSS-REFERENCE TO RELATED APPLICATIONS

This present application is a National Phase entry of PCT Application No. PCT/EP2023/079643, filed Oct. 24, 2023, which claims priority from Great Britain Application No. 2216090.7, filed Oct. 31, 2022, each of which are fully incorporated herein by reference in their entireties.

### TECHNICAL FIELD

The present invention relates to an aerosol provision device and an aerosol provision system.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately induction heating systems are known to be used as heaters.

### SUMMARY

According to an aspect there is provided an aerosol provision device configured to heat at least part of an article comprising aerosol generating material, comprising: a receptacle for receiving at least a portion of the article; the receptacle comprising a reflecting surface arranged to reflect electromagnetic radiation towards the article; wherein the reflecting surface has a minimum reflectivity of electromagnetic radiation with a wavelength between 1000 nm and 700 nm of at least 60%.

The reflecting surface may have an average reflectivity of electromagnetic radiation with a wavelength between 1000 nm and 700 nm of at least 70%. The reflecting surface may have a mean reflectivity of electromagnetic radiation with a wavelength between 1000 nm and 700 nm of at least 70%.

The reflecting surface may have a minimum reflectivity of electromagnetic radiation with a wavelength between 1000 nm and 700 nm of between 70% and 85%.

The aerosol provision device may comprise a heater. The heater may define at least part of the receptacle.

The heater may be a resistive heating heater. The heater may comprise a housing and a resistive heating element in the housing. The resistive heating element may comprise a resistive heating coil.

The heater may be an inductive heating heater. The heater may comprise an inductive coil.

The heater may protrude in the receptacle.

The receptacle may comprise a peripheral wall at least partially extending around the heater. The peripheral wall may comprise the reflecting surface.

The receptacle may define at least a portion of a chamber. The heater may be exposed to the chamber.

The reflecting surface may encircle the chamber.

The reflecting surface may extend over at least 50%, at least 75% or at least 90% of the peripheral extent of the chamber.

The receptacle may comprise a base wall from which the heater upstands.

The base wall may comprise the reflecting surface.

The reflecting surface may be radially evenly distributed with respect to the position occupied by the article when received in the receptacle.

The reflecting surface may be arranged such that the amount of radiation reflected by the receptacle varies along a longitudinal extent of the receptacle.

The reflecting surface may be arranged such that the amount of radiation reflected by the receptacle varies in a step-wise manner along the longitudinal extent of the receptacle. The reflecting surface may be arranged such that the amount of radiation reflected by the receptacle varies in a continuous manner along the longitudinal extent of the receptacle.

The reflecting surface may be arranged such that a greater portion of electromagnetic radiation with a wavelength between 1000 nm and 700 nm is reflected by a proximal portion of the receptacle compared to a distal portion of the receptacle, the proximal portion being closer to the user in use. The reflecting surface may be arranged such that a lesser portion of electromagnetic radiation with a wavelength between 1000 nm and 700 nm is reflected by a proximal portion of the receptacle compared to a distal portion of the receptacle, the proximal portion being closer to the user in use.

The reflecting surface may be arranged to provide a temperature gradient along the longitudinal extent of the receptacle in use.

The reflecting surface may be arranged to compensate for a temperature gradient along the longitudinal extent of the receptacle in use.

The receptacle may comprise a first longitudinal portion comprising the reflecting surface and a second longitudinal portion free from the reflecting surface.

The first longitudinal portion may comprise at least 50%, at least 75% or at least 90% of the longitudinal extent of the receptacle.

The reflecting surface may comprise a first reflecting surface and a second reflecting surface. The first reflecting surface may have a different reflectivity of electromagnetic radiation than the second reflecting surface.

The reflecting surface may comprise a sheet. The sheet may have a thickness of between 0.1 mm and 10 mm. The sheet may be adhered to another part of the receptacle, such as the peripheral wall. The sheet may be joined to the peripheral wall by a fixing, such as a mechanical fastener. The sheet may form an interference fit with the peripheral wall. The sheet may be retained to the peripheral wall by another component of the aerosol provision device. The sheet may form at least part of the receptacle.

The sheet may comprise a foil. The foil may be aluminium foil. Alternatively, the reflecting surface may be thicker than a foil, such as a sheet other than a foil.

The reflecting surface may comprise a coating. For example, the reflecting surface may be painted, sprayed and/or deposited to define a surface of the receptacle. The coating may comprise aluminium or ceramics.

The reflecting surface may comprise one or more of Mylar; Aluminised PET Films; Foylon and Polyimide Films.

The reflecting surface may comprise a thermal insulator.

The reflecting surface may comprise a dielectric material.

The reflecting surface may comprise a surface finish. The surface finish may include a polished surface. Surface finish may be formed by at least one of grinding, polishing, including electro-polishing, lapping and honing. The surface finish may be a surface finish of at least one of the peripheral wall and the base.

The reflecting surface may comprise at least one of a metal and metal alloy.

The receptacle may comprise a support and the reflecting surface may be on the support. The support may comprise the base wall and/or or the peripheral wall. The support may have a surface finish defining the reflecting surface.

The receptacle may comprise a plurality of layers and the reflecting surface may be the innermost layer.

The aerosol provision device may comprise a protective layer over the reflecting surface. This may protect the reflecting surface from damage during insertion or removal of the article or during cleaning.

The aerosol provision device may comprise a power source, a controller and a heating chamber, in which the aerosol generating article is removably received. The power source may be aligned along a longitudinal axis of the heating chamber. The power source may be aligned along a second longitudinal axis, parallel to the longitudinal axis of the heating chamber.

The aerosol provision device may be configured for wireless charging.

According to an aspect there is provided an aerosol provision system comprising: an aerosol provision device as described above; and an article comprising aerosol generating material.

The aerosol provision system may comprise a charging unit having a cavity for removably receiving the aerosol provision device. The charging unit may comprise a moveable lid, which covers the aerosol provision device in a closed configuration. The charging unit may comprise a user display. The user display may be visible to a user when the moveable lid is in a closed position and is partially or fully concealed or obscured from sight by the lid when the lid is an open position.

According to another aspect there is provided a method of generating aerosol comprising: providing an aerosol provision device according to the first aspect and at least partially inserting an aerosol generating article into the receiving portion of the heating chamber.

### BRIEF DESCRIPTION OF THE DRAWINGS

Various embodiments will now be described, by way of example only, and with reference to the accompanying drawings, in which:

FIG. 1 shows a perspective view of an aerosol provision system including an aerosol provision device located within a charging unit;

FIG. 2 shows a schematic cross-sectional view of part of the aerosol provision device of FIG. 1;

FIG. 3 shows a schematic cross-sectional view of part of the aerosol provision device of FIG. 1 and an aerosol generating article of the aerosol provision system;

FIG. 4 shows a perspective view of another aerosol provision device;

FIG. 5 shows a schematic cross-sectional view of the device of FIG. 4;

FIG. 6 shows a schematic cross-sectional view of a heater of the device of FIG. 1 or FIG. 4;

FIG. 7 shows a schematic cross-sectional view of part of another aerosol provision device; and

FIG. 8 shows a schematic cross-sectional view of part of another aerosol provision device.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

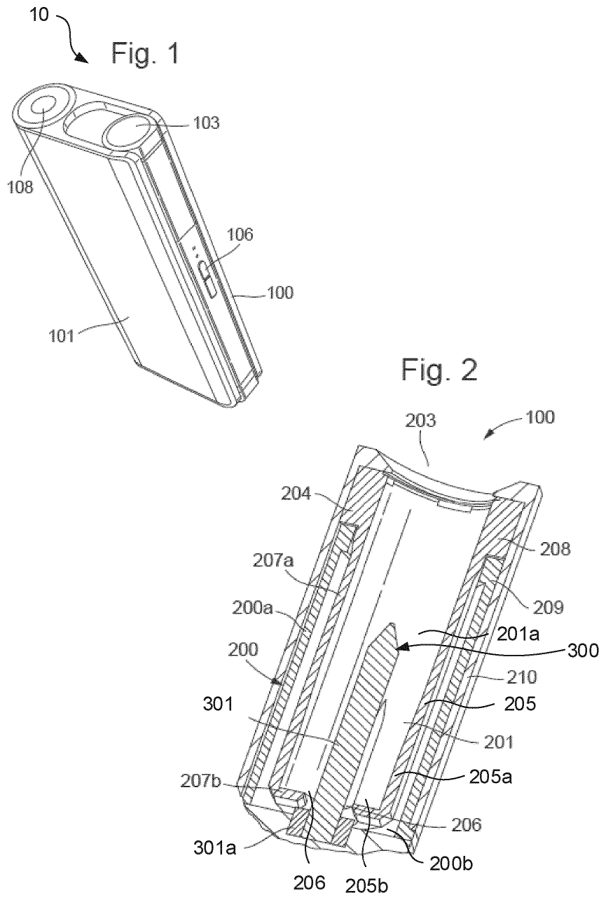

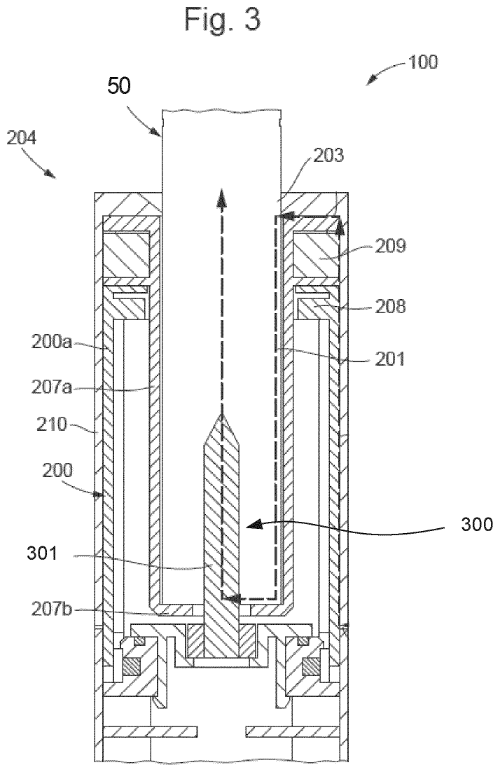

FIG. 1 shows an aerosol provision system 10 comprising an aerosol provision device 100 and a charging unit 101. The device is shown located within a cavity of a charging unit 101. The aerosol provision device 100 is arranged to generate aerosol from an aerosol generating article (refer to FIG. 3) which may be inserted, in use, into the aerosol provision device 100. In embodiments, the article forms part of the aerosol provision system 10.

The aerosol provision device 100 is an elongate structure, extending along a longitudinal axis. Additionally, the aerosol provision device has a proximal end, which will be closest to the user (e.g. the user's mouth) when in use by the user to inhale the aerosol generated by the aerosol provision device 100, as well as a distal end which will be furthest from the user when in use. The proximal end may also be referred to as the “mouth end”. The aerosol provision device 100 also accordingly defines a proximal direction, which is directed towards the user when in use. Further, the aerosol provision device 100 also likewise defines a distal direction, which is directed away from the user when in use. The terms proximal and distal as applied to features of the device 100 will be described by reference to the relative positioning of such features with respect to each other in a proximal-distal direction along a longitudinal axis. The aerosol provision device 100 comprises an opening at the distal end, leading into a heating chamber.

The aerosol provision device 100 may be removably inserted into the charging unit 101 in order to be charged. The charging unit 101 comprises a cavity (refer to FIG. 2) for receiving the aerosol provision device 100. The aerosol provision device 100 may be inserted into the cavity via an opening. The cavity may also comprise a longitudinal opening. A portion of the aerosol provision device 100 may comprise a first side. One or more user-operable control elements such as buttons 106 which can be used to operate the aerosol provision device 100 may be provided on the first side of the aerosol provision device 100. The first side of the aerosol provision device 100 may be received in the longitudinal opening provided in the charging unit 101.

In embodiments the cavity of the charging unit 101 may have a cross-sectional profile which only permits that the aerosol provision device 100 be inserted into the charging unit 101 in a single orientation. According to an embodiment the outer profile of the aerosol provision device 100 may comprise an arcuate portion and a linear portion. The cross-sectional profile of the cavity provided in the charging unit 101 may also comprise a similar arcuate portion and a linear portion. The linear portion of the cross-sectional profile of the cavity may correspond with the longitudinal opening.

The charging unit 101 includes a slidable lid 103. When the aerosol provision device 100 is inserted into the charging unit 101 in order to be recharged, the slidable lid 103 may be closed so as to cover the opening into the aerosol provision device 100. In other embodiments, the charging unit 101 may have an alternative lid configuration, such as a hinged or pivoted lid, or no lid may be provided.

The charging unit 101 may include a user interface such as display 108, which can be provided at any convenient location, such as in the position shown in FIG. 1.

FIG. 2 shows a cross sectional view of a portion of the aerosol provision device 100. The aerosol provision device 100 comprises a main housing 200. The main housing 200 defines a device body of the device 100. The device 100 defines a heating chamber 201. A receptacle 205 defines the heating chamber 201. An opening 203 is provided to provide access to the heating chamber 201. The receptacle 205 comprises a wall arrangement including a receptacle peripheral wall 205a and a base wall 205b. The base wall 205b is at the distal end of the receptacle 205. A heating zone 201a is configured to receive at least a portion of the article for heating.

A heating member 301 is provided in a portion of the main housing 200 and the heating member 301 extends or projects into the heating chamber 201. The heating member 301 may comprise a base portion 301a which may be located in a recess provided in a portion of the body of the device 100. The heating member 301 upstands in the heating chamber 201. The heating member 301 upstands from the distal end.

The heating member 301 comprises an elongate heating member in the form of a pin. The heating member 301 in other embodiments comprises other elongate configurations, such as a blade. The heating member 301 may be inserted, in use, into a distal end of an aerosol generating article 50 (refer to FIG. 3) which is received within the heating chamber 201 in order to internally heat the aerosol generating article.

The housing comprises housing wall 200a. The housing wall 200a extends along the longitudinal axis of the aerosol provision device 100, surrounding the heating chamber 201. The housing wall 200a may, at least in part, define a receiving chamber of the aerosol provision device 100, as the volume which is enclosed within the wall 200a. A housing base 200b is at the distal end of the housing wall 200a. In the shown embodiment, the heating member 301 upstands from the housing base 200b. The heating member 301 protrudes through the receptacle base wall 205b. An aperture 206 is formed in the receptacle base wall 205b through which the heating member 301 protrudes. In embodiments, the heating member 301 is mounted to the receptacle base wall 205b. The heating member 301 upstands from the receptacle base wall 205b.

The aerosol provision device 100 further comprises a removal mechanism 204 which may be removably retained to the main housing 200 of the aerosol provision device 100. The removal mechanism 204 in embodiments is omitted. In embodiments, the housing wall 200a at least in part defines the receptacle 205. The removal mechanism 204 may be retained to the main housing 200 so that at least a portion of the removal mechanism 204 extends into the heating chamber 201. The removal mechanism 204 may comprise a longitudinal portion such as a peripheral wall portion 207a, which in the present embodiment is tubular, and a base wall portion 207b. The wall 207a may be a shape other than tubular, and may be any shape which encloses (e.g. encircles) and defines the heating chamber 201 there within.

In embodiments with the removal mechanism 204, the removal mechanism 204 defines the heating chamber 201. The removal mechanism 204 forms the receptacle 205. In embodiments in which the removal mechanism 204 is omitted, other features of the device 100 define the heating chamber 201, for example the housing side wall 200a and housing base 200b.

The base portion 207b has the aperture 206 through which the heating member 301 may project. In order to retain the removal mechanism 204 to the main housing 200, the removal mechanism 204 is pushed into engagement with the main housing 200 in the distal direction, i.e. towards the distal end of the main housing 200, until the removal mechanism 204 is able to move no further in the distal direction. In the following description, when the removal mechanism 204 is referred to as being “retained to” the main housing 200, this is when the removal mechanism 204 is engaged with the main housing 200, and can move no further in the distal direction.

Together, the peripheral portion 207a and the base portion 207b may define and enclose an article chamber for receiving, the aerosol generating article 50, as shown in FIG. 3. The article chamber comprises an inner surface, which is configured to contact the aerosol generating article, the inner surface comprising a longitudinally extending portion which is provided by the tubular portion 207a, and an end portion which is provided by the base portion 207b. In embodiments, the article chamber and the heating chamber are the same. When the aerosol generating article 50 is received in the heating chamber, it may contact both the longitudinally extending portion of the inner surface, and the end portion of the inner surface. In particular, the article chamber (i.e. the peripheral portion 207a and the base portion 207b) may be configured to receive at least part of the aerosol generating article 50 which is in the form of rod which is longitudinally extending and cylindrical, such that the longitudinal axis of the article is parallel to (and optionally in line with) the longitudinal axis of the aerosol provision device 100 when received in the article chamber.

The article chamber may also be referred to as a receiving portion. When the removal mechanism 204 is retained to the main housing 200, in use, the article chamber of the removal mechanism 204 is arranged, at least partially, within the heating chamber 201. The heating member 301 may be arranged so as to project into the article chamber, through the aperture 206 provided in the base portion 207b of the removal mechanism 204. The removal mechanism 204 is therefore configured to receive at least a portion of the aerosol generating article in use.

In embodiments, the removal mechanism 204 may comprise a first magnet or a magnetisable material 208. The main housing 200 may comprise a second magnet or magnetisable material 209. In use, the removal mechanism 204 may be magnetically retained to the main housing 200 by the interaction of the first magnet or magnetisable material 208 and the second magnet or magnetisable material 209.

In embodiments, the removal mechanism 204 is fully detachable from the main housing 200. The removal mechanism 204 may be retained to the main housing 200 by a magnetic force of attraction between the first magnet or magnetisable material 208 and the second magnet or magnetisable material 209. The removal mechanism 204 may be detached from the main housing 200 by overcoming the magnetic force between the first magnet or magnetisable material 208 and the second magnet or magnetisable material 209. In embodiments, the removal mechanism 204 is removably retained to the main housing 200 by other means. For example, the removal mechanism 204 may be configured to be removably retained to the main housing 200 by an interference fit with the main housing.

The removal mechanism 204 may comprise an internal element (comprising the tubular portion 207a and a base portion 207b) and an outer cap portion 210, wherein when retained to the main housing 200 the outer cap portion 210 encapsulates (e.g. covers) at least a portion of the main housing 200, such as the wall 200a of the main housing. The tubular portion 207a, base portion 207b and outer cap portion 210 may comprise an integral (e.g. unitary) component (formed, for example, by moulding). Alternatively, the tubular portion 207a and base portion 207b may comprise a first component and the outer cap portion 210 may comprise a second separate component. The first and second components may then be secured together.

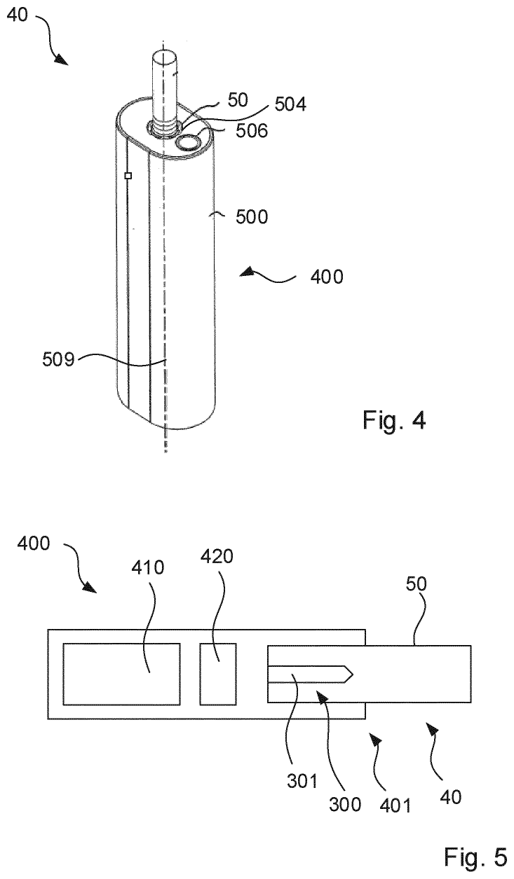

FIG. 4 shows another aerosol provision system 40. The system 40 comprises a one-piece aerosol provision device 400 for generating aerosol from an aerosol generating material, and the aerosol generating article 50 comprising the aerosol generating material. The device 400 can be used to heat the aerosol generating article 50 comprising the aerosol generating material, to generate an aerosol or other inhalable medium which can be inhaled by a user of the device 400.

The device 400 comprises a housing 500 which surrounds and houses various components of the device 400. The housing 500 is elongate. The device 400 has an opening 504 in one end, through which the article 50 can be inserted for heating by the device 400. The article 50 may be fully or partially inserted into the device 400 for heating by the device 400.

The device 400 may comprise a user-operable control element 506, such as a button or switch, which operates the device 400 when operated, e.g. pressed. For example, a user may activate the device 400 by pressing the switch 406.

The device 400 defines a longitudinal axis 509 along which an article 50 may extend when inserted into the device 400. The opening 504 is aligned on the longitudinal axis 509.

FIG. 5 shows a cross-sectional schematic view of the aerosol provision system 40. Features described with reference to FIG. 5 in embodiments are applicable to embodiments described above. The aerosol provision device 400 comprises a power source 410, a controller 420 and a heating chamber 401, in which the aerosol generating article 50 is removeable received.

The one-piece device of FIG. 5 shows the power source 410 aligned along the longitudinal axis of the heating chamber 401. In another embodiment of a one-piece aerosol generating device, the power source is aligned along a second longitudinal axis, parallel to the longitudinal axis of the heating chamber.

The heating member 301 comprises an elongate heating member in the form of a pin. The heating member 301 in embodiments comprises other elongate configurations, such as a blade. The heating member 301 is provided in the heating chamber. The heating member 301 of FIG. 5 and the heating member 301 described above with reference to FIGS. 1 to 3, such that details described herein may be applied to each. The heating member 301 extends or projects into the heating chamber 401.

The heating member 301 may be inserted, in use, into a distal end of the aerosol generating article which is received within the heating chamber 401 in order to internally heat the aerosol generating article.

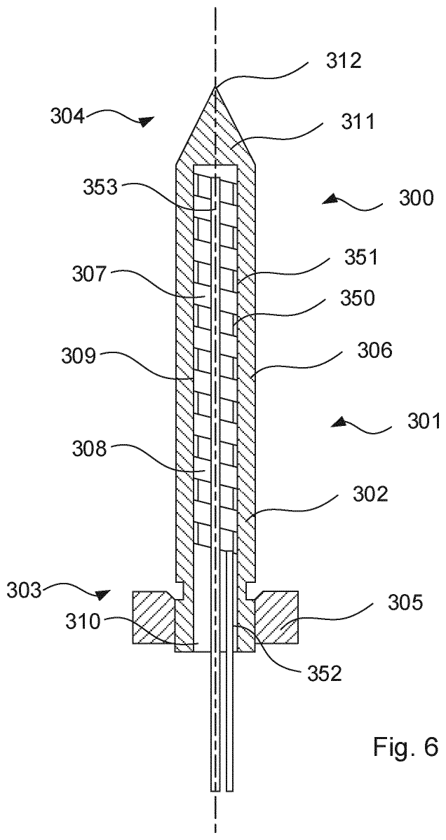

The aerosol provision devices 100, 400 comprise a heating arrangement 300. The heating arrangement 300 comprises a heater. The heating member 301 acts as the heater. The heater comprises a heating element 350 (refer to FIG. 6), such as a resistive heating coil, arranged to be actuated to heat the heating member.

The heating arrangement 300 is a resistive heating arrangement. The heater is a resistive heating heater. The heating element, such as a heating coil, as will be described below is a resistive heating element. In such arrangements the heating assembly comprises a resistive heating generator including components to heat the heating element via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement comprises electrical contacts for supplying electrical current to the resistive material. In embodiments, the heating element forms at least part of the resistive heating member itself. In embodiments the resistive heating element transfers heat to the heating member, for example by conduction. The provision of a resistive heating arrangement allows for a compact arrangement. Resistive heating provides an efficient configuration.

FIG. 6 shows the heating member 301 for use in an aerosol provision device as described above. The heating member 301 acts as or forms at least part of a heater. The heating arrangement 300 comprises the heating member 301. The heating member 301 comprises an elongate housing 302 and the heating element 350. The elongate housing 302 is an elongate member defining a longitudinal axis.

The housing 302 is formed from a thermally conductive material, such as aluminium. Other suitable materials, such as stainless steel or ceramic may be used. The elongate housing may comprise a coating on its outer surface. The elongate housing 302 is configured to transfer heat from the heating element 350 to the heating zone 201a.

The elongate housing 302 has a base end 303 and a free end 304. The base end 304 mounts to the device body. A mount 305 at the base end 303 mounts the heating member 301. It will be understood that different mounting arrangements may be used, for example a fixing, moulding, and bonding including adhering. The mount 305 may be a separate component or may be integrally formed with the elongate housing 302.

The elongate housing 302 comprises a housing body 306. The housing body 306 is tubular. The housing body 306 comprises a bore 307. The bore 307 defines an inner void 308 of the heating member 301. The inner void 308 extends longitudinally. In embodiments, the inner void 308 is at least partially filled, for example with a filler. In embodiments, the inner void 308 is completely filled, for example with one or more fillers and/or components. In embodiments, the inner void 308 defines an air gap. An inner surface 309 is defined on an inner side of the elongate housing 302. An open end 310 to the inner void 308 is provided at the base end 303.

The free end 304 of the elongate housing 302 extends towards the proximal end of the heating chamber. The free end 304 of the heating member 301 is closed. The inner void 308 does not extend through the free end 304. A tip 311 is provided at the free end 304. The tip 311 extends to an apex 312. Other shapes and configurations of the tip 311 may be provided, for example the tip 311 may define a planar surface.

The heating element 350 extends in the heating member 301. The heating element 350 extends in the elongate housing 302 in the longitudinal direction. The heating element 350 is received in the inner void 308. The heating element 350 extends between the base end 303 and the distal end 304. In embodiments, the heating element extends partially along the length of the inner void 308. In embodiments the heating element 350 extends to or beyond the open end 310.

The heating element 350 in embodiments comprises a heating coil 351. The heating coil 351 comprises a resistive member defining the heating coil 351. In embodiments the heating coil 351 comprises an electrically insulative coating, such as a ceramic, to electrically insulate the heating coil 351 from the elongate housing 302. The electrically insulative coating in embodiments is thermally conductive to provide for heat transfer from the heating element 350 to the elongate housing 302. In embodiments the electrically insulative coating is omitted. In embodiments, a separate electrically insulative arrangement, such as at least one of an electrically insulative member and an electrically insulative filler is provided. The electrically insulative member and electrically insulative filler in embodiments is thermally conductive to provide for heat transfer from the heating element 350 to the elongate housing 302.

The heating coil 351 is a resistive heating coil. The heating coil 351 is a helical coil. The heating coil 351 has a rectangular cross-sectional profile. It will be understood that other coil configurations are possible. In embodiments, the heating coil 351 has a circular cross-sectional profile. In embodiments, the heating arrangement 300 comprises two or more heating coils.

The heating arrangement 300 comprises electrical connection paths. The electrical connection paths extend from each end of the heating element 350. A base electrical connection path 352 extends from the distal end of the heating element 350. A return electrical connection path 353 extends from the proximal end of the heating element 350. The return electrical connection path overlaps the longitudinal extent of the heating element 350. The electrical connection paths are integrally formed with the heating element, for example as a single wire. In embodiments, connectors connect the electrical connection paths with the heating element 350. The heating coil 351 is formed from a resistive material, such as a nickel/chrome alloy such as nichrome 80/20 (80% Nickel, 20% Chromium), an iron/chrome/aluminium alloy, or a copper/nickel alloy.

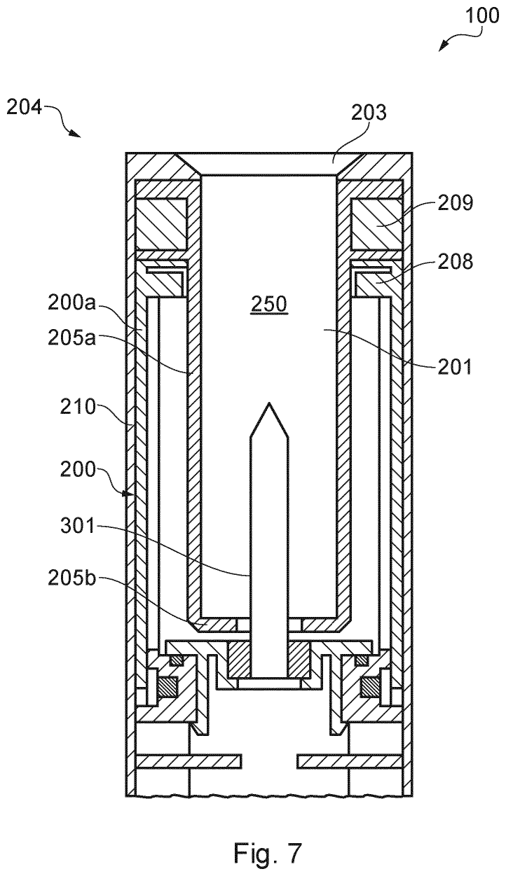

FIG. 7 shows part of an aerosol provision device 100. The aerosol provision device 100 is similar to the aerosol provision devices described above, for example with reference to FIGS. 1 to 6. For brevity, like reference numerals will be used and only the differences will be described. The aerosol provision device 100 comprises a heating member 301. The heating member 301 is the heating member 301 of FIG. 6. In other embodiments the heating member could be a different heating member, for example a tubular heater forming the receptacle. The heating member itself in embodiments comprises the receptacle. For simplicity, the features of the heating member 301 are not all shown in FIG. 7.

In the aerosol provision device 100 of FIG. 7, the receptacle 205 comprises a reflecting surface 250. The reflecting surface 250 is arranged to reflect electromagnetic radiation towards the article 50. That is, towards the position in which the article 50 is located in use. That is, towards the heating chamber 201.

The reflecting surface 250 has a minimum reflectivity of electromagnetic radiation with a wavelength between 1000 nm and 700 nm of at least 60%. That is, the reflectivity of the reflecting surface 250 is not lower than 60% for any wavelength between 1000 nm and 700 nm. In embodiments, the minimum value of reflectivity in this range may be at any wavelength in the range. In embodiments, the minimum value of reflectivity in this range may be greater than 60%.

The reflecting surface may have a minimum reflectivity of electromagnetic radiation with a wavelength between 1000 nm and 700 nm of between 70% and 85%.

The reflecting surface 250 has an average reflectivity of electromagnetic radiation with a wavelength between 1000 nm and 700 nm of at least 70%. The reflecting surface 250 has a mean reflectivity of electromagnetic radiation with a wavelength between 1000 nm and 700 nm of at least 70%.

In use, the reflecting surface may reflect electromagnetic radiation towards the article. The reflecting surface may reflect infrared radiation particularly strongly. Heat originating from the heating of the article may therefore be at least partially prevented from leaving the article and the aerosol provision device. This may improve the energy efficiency of the aerosol provision device because less heat energy may be needed to raise the article to a desired operating temperature and/or to maintain the article at a desired operating temperature. The user experience and/or safety may also be improved because less or no heat may be transmitted to an exterior of the aerosol provision device. This may prevent the exterior of the aerosol provision device from reaching a temperature which is uncomfortable or unsafe for the user to hold. The user experience and/or utilisation of aerosol generating material may also be improved, because an in use temperature profile of the article may be altered in a desired manner by the reflecting surface. The reflecting surface may allow more efficient utilisation of the aerosol generating material and may allow the user experience to be improved by reducing hot-spots in the article.

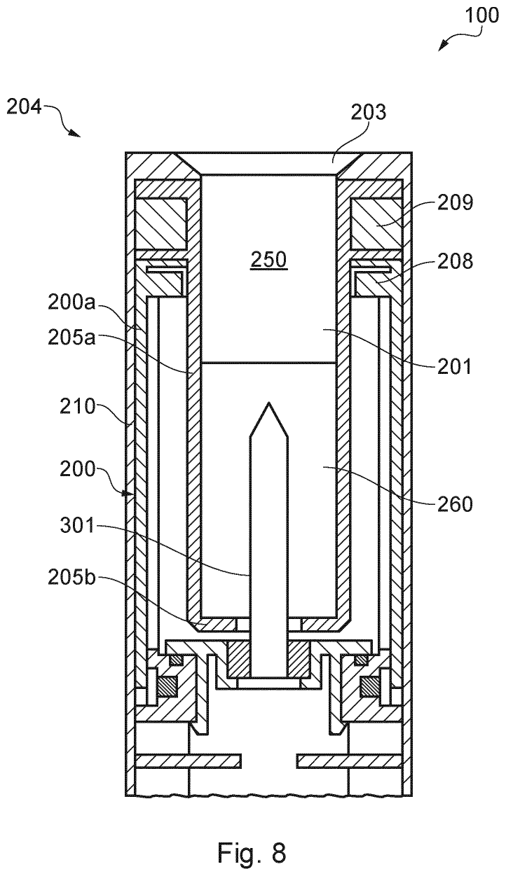

The reflecting surface 250 is on the peripheral wall 205a. The reflecting surface 250 is on an inner surface of the peripheral wall 205a. The inner surface of the peripheral wall 205a is the surface which is exposed to the heating chamber 201. The reflecting surface 250 covers the entire inner surface of the peripheral wall 205a. In embodiments, such as the aerosol provision device 100 shown in FIG. 8 described below, the reflecting surface 250 only covers part of the inner surface of the peripheral wall 205a. That is, in embodiments, part of the inner surface of the peripheral wall 205a is free from the reflecting surface 250. That is, part of the inner surface of the peripheral wall 205a has a minimum reflectivity of electromagnetic radiation with a wavelength between 1000 nm and 700 nm of below 60%.

In such embodiments, part of the inner surface of the peripheral wall 205a may have an average reflectivity of electromagnetic radiation with a wavelength between 1000 nm and 700 nm of below 70%. In such embodiments, part of the inner surface of the peripheral wall 205a may have a mean reflectivity of electromagnetic radiation with a wavelength between 1000 nm and 700 nm of below 70%.

The reflecting surface 250 encircles the heating chamber 201. This may further improve the user experience, energy efficiency and/or safety of the aerosol provision device by ensuring a larger proportion of the infrared energy from heating of the article is reflected by the reflecting surface.

The term ‘encircles’ will be understood to mean that the reflecting surface 250 extends around at least 90% of a peripheral extent of the heating chamber 201. The term ‘peripheral extent’ will be understood to mean an extent falling within a certain angular range. That is, the term ‘peripheral extent’ may be considered synonymous with a radial extent. The term ‘radial extent’ will not be understood to imply that a body referred to as having a radial extend has any particular form or cross-section, such as a rotationally symmetric form or a circular cross-section. In embodiments, the reflecting surface 250 extends over at least 50%, at least 75% or at least 90% of the peripheral extent of the heating chamber 201. This may provide a desired balance between complexity, material and manufacturing costs on the one hand, and on the other hand further improvement of the user experience, energy efficiency and/or safety of the aerosol provision device by ensuring a larger proportion of the infrared energy from heating of the article is reflected by the reflecting surface.

The reflecting surface 250 is also provided on the receptacle base wall 205b. The reflecting surface 250 is also provided on an inner surface of the receptacle base wall 205b. The inner surface of the receptacle base wall 205b is exposed to the heating chamber 201. That is, part of the reflecting surface 250 is provided on the receptacle base wall 205b. Some infrared energy may be emitted in an axial direction of the aerosol provision device. Providing at least part of the reflecting surface 250 on the base wall 205b may allow at least part of this energy to be reflected back towards the article. This may further improve the user experience, energy efficiency and/or safety of the aerosol provision device by ensuring infrared energy from heating of the article which is emitted towards the base wall 205b of the receptacle is reflected by the reflecting surface 250.

In embodiments, the receptacle base wall 205b may be free from the reflecting surface 250. That is the inner surface of the receptacle base wall 205b may have a minimum reflectivity of electromagnetic radiation with a wavelength between 1000 nm and 700 nm of below 60%. In such embodiments, the inner surface of the receptacle base wall 205b may have an average reflectivity of electromagnetic radiation with a wavelength between 1000 nm and 700 nm of below 70%. In such embodiments, the inner surface of the receptacle base wall 205b may have a mean reflectivity of electromagnetic radiation with a wavelength between 1000 nm and 700 nm of below 70%.

The reflecting surface 250 is radially evenly distributed with respect to the position occupied by article 50 when received in the receptacle 205. This may provide a more even temperature profile around the circumference of the article. This may improve the user experience and/or utilisation of aerosol generating material by the aerosol provision device, for example by avoiding hot-spots, which may lead to burning of the aerosol generating material and consequent poor user experience, and/or areas of under-heating which may lead to under-utilisation of aerosol generating material.

The reflecting surface 250 comprises a sheet of Mylar. In other embodiments, the reflecting surface may comprise an aluminised PET film, foylon or a polyimide film. The sheet has a thickness of 1 mm. In other embodiments the sheet may have a thickness of between 0.1 and 10 mm. The sheet is adhered to the peripheral wall. The peripheral wall therefore acts as a support. In embodiments, the sheet may be joined to other parts of the receptacle and those may act as the support. In other embodiments, the sheet may be joined to the peripheral wall by a fixing such as a mechanical fastener or may form an interference fit with the peripheral wall or be retained to the peripheral wall by another component of the aerosol provision device. The sheet forms part of the receptacle. The reflecting surface 250 comprises a polished surface. This may increase the reflectivity of the reflecting surface. A protective layer is provided on the reflecting surface.

In embodiments, the sheet comprises a foil. In embodiments, the reflecting surface comprises a coating. The coating may be painted, sprayed and/or deposited to define a surface of the receptacle. In embodiments, the reflecting surface is not a separate feature of the receptacle. For example, the reflecting surface may be a polished area on the peripheral wall.

The reflecting surface 250 may be considered to be a layer of the receptacle 201. The receptacle 201 therefore comprises a plurality of layers. The reflecting surface 250 is the innermost layer. That is, the reflecting surface 250 is exposed to and at least partially defines the heating chamber 201.

The reflecting surface may comprise a thermal insulator. This may further improve the user experience and/or safety of the aerosol provision device, by reducing an in-use temperature of an exterior of the aerosol provision device, for example an exterior temperature of the aerosol provision device at the end of a use session.

The reflecting surface may comprise a dielectric material. The reflecting surface may comprise at least one of a metal and a metal alloy.

In embodiments, the reflecting surface is formed by a surface finish. The surface finish may include a polished surface. The surface finish may be formed by at least one of grinding, polishing, including electro-polishing, lapping and honing. The surface finish may be a surface finish of at least a portion of one of the peripheral wall and the base.

FIG. 8 shows part of an aerosol provision device 100. The aerosol provision device 100 is similar to the aerosol provision device 100 of FIG. 7. For brevity, like reference numerals will be used and only the differences will be described.

In the aerosol provision device 100 of FIG. 8, the reflecting surface 250 is arranged such that the amount of radiation reflected by the receptacle 201 varies along a longitudinal extent of the receptacle 201. The longitudinal extent of the receptacle 201 is in a direction parallel to the aforementioned longitudinal axis of the aerosol provision device 100.

This may further improve the user experience and/or utilisation of aerosol generating material by altering an in use temperature profile of the article in a desired way. For example, a desired temperature gradient may be provided to provide a desire user experience. Alternatively or additionally, an otherwise existing in use temperature gradient of the article may be compensated for. This may avoid hot-spots, which may lead to burning of the aerosol generating material and consequent poor user experience, and/or areas of under-heating which may lead to under-utilisation of aerosol generating material.

The receptacle 201 comprises a first longitudinal portion 260 comprising the reflecting surface 250 and a second longitudinal portion 261 free from the reflecting surface 250. That is the second longitudinal portion 261 may have a minimum reflectivity of electromagnetic radiation with a wavelength between 1000 nm and 700 nm of below 60%. In such embodiments, the second longitudinal portion 261 may have an average reflectivity of electromagnetic radiation with a wavelength between 1000 nm and 700 nm of below 70%. In such embodiments, the second longitudinal portion 261 may have a mean reflectivity of electromagnetic radiation with a wavelength between 1000 nm and 700 nm of below 70%.

The reflecting surface 250 provides a temperature change along the longitudinal extent of the receptacle 201 in use. This is because heat is reflected by the reflecting surface 250 back to the article 50. Areas adjacent to the reflecting surface therefore retain more heat, and reach higher temperatures. In embodiments, the reflecting surface 250 may be arranged to compensate for a temperature change along the longitudinal extent of the receptacle 201 which would otherwise be present in use.

The reflecting surface 250 is therefore arranged such that the amount of radiation reflected by the receptacle 201 varies in a step-wise manner along the longitudinal extent of the receptacle. In other embodiments, the reflecting surface 250 may be arranged such that the amount of radiation reflected by the receptacle 201 varies in a continuous manner along the longitudinal extent of the receptacle 201. A desired balance may therefore be obtained between complexity, material and manufacturing costs on the one hand, and on the other hand further improvement of the user experience, energy efficiency and/or safety of the aerosol provision device. For example, variation in a step-wise manner may be simpler and/or cheaper to provide, while variation in a continuous manner may provide further improvements in energy efficiency, user experience and/or utilisation of aerosol generating material. In some such embodiments, the reflecting surface 250 may be arranged to provide a temperature gradient along the longitudinal extent of the receptacle 201 in use. In other such embodiments, the reflecting surface 250 may be arranged to compensate for a temperature gradient along the longitudinal extent of the receptacle 201 in use.

The first longitudinal portion 260 comprises 50% of the longitudinal extent of the receptacle 201. In other embodiments, the first longitudinal portion 260 comprises a different amount of the longitudinal extend of the receptacle 201, for example at least 75% or at least 90%.

The first longitudinal portion 260 is provided at a proximal end of the receptacle 201 and the second longitudinal portion 261 is provided at a distal end of the receptacle 201. The reflecting surface 250 is therefore arranged such that a greater portion of electromagnetic radiation with a wavelength between 1000 nm and 700 nm is reflected by a proximal portion of the receptacle 201 compared to a distal portion of the receptacle 201, the proximal portion being closer to the user in use. This may improve the user experience by providing or compensating for progressive heating as desired and/or causing a larger amount of aerosol to be generated at a beginning or end of a use session as desired. In other embodiments, the reflecting surface 250 may be arranged such that a lesser portion of electromagnetic radiation with a wavelength between 1000 nm and 700 nm is reflected by a proximal portion of the receptacle 201 compared to a distal portion of the receptacle 201, the proximal portion being closer to the user in use. For example, the first longitudinal portion 260 may be provided at a distal end of the receptacle 201 and the second longitudinal portion 261 may be provided at a proximal end of the receptacle 201.

In embodiments, the reflecting surface 250 may comprise a first reflecting surface and a second reflecting surface. The first reflecting surface may have a different reflectivity of electromagnetic radiation than the second reflecting surface.

The first reflecting surface may have a minimum reflectivity of electromagnetic radiation with a wavelength between 1000 nm and 700 nm of at least 70%. The first reflecting surface may have an average reflectivity of electromagnetic radiation with a wavelength between 1000 nm and 700 nm of at least 80%. The first reflecting surface may have a mean reflectivity of electromagnetic radiation with a wavelength between 1000 nm and 700 nm of at least 80%. The second reflecting surface may have a minimum reflectivity of electromagnetic radiation with a wavelength between 1000 nm and 700 nm of at least 60%. The second reflecting surface may have an average reflectivity of electromagnetic radiation with a wavelength between 1000 nm and 700 nm of at least 70%. The second reflecting surface may have a mean reflectivity of electromagnetic radiation with a wavelength between 1000 nm and 700 nm of at least 70%. The first reflecting surface may have a minimum reflectivity of electromagnetic radiation with a wavelength between 1000 nm and 700 nm greater than a minimum reflectivity of electromagnetic radiation with a wavelength between 1000 nm and 700 nm of the second reflecting surface. The first reflecting surface may have an average reflectivity of electromagnetic radiation with a wavelength between 1000 nm and 700 nm greater than an average reflectivity of electromagnetic radiation with a wavelength between 1000 nm and 700 nm of the second reflecting surface. The first reflecting surface may have a mean reflectivity of electromagnetic radiation with a wavelength between 1000 nm and 700 nm greater than a mean reflectivity of electromagnetic radiation with a wavelength between 1000 nm and 700 nm of the second reflecting surface. The first and second reflecting surfaces could be parts of a continuous surface or they could be separate surfaces.

In the above described embodiments, the heating arrangement is a resistive heating arrangement. In embodiments, other types of heating arrangement are used, such as inductive heating. The configuration of the device is generally as described above and so a detailed description will be omitted.

An inductive heating arrangement comprises various components to heat the aerosol generating material of the article via an inductive heating process. Induction heating is a process of heating an electrically conducting heating member (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating member) suitably positioned with respect to the inductive element. In inductive heating, as compared to heating by conduction for example, heat is generated inside the susceptor, allowing for rapid heating. Further, there need not be any physical contact between the inductive element and the susceptor, allowing for enhanced freedom in construction and application.

In inductive heating heat is generated in the susceptor (heating member) whereas in resistive heating heat is generated in the coil (heating element).

In embodiments, the heating member of the aerosol provision system is a part of the aerosol generating article, rather than being a part of the aerosol provision device. The heating element may be a resistive heating element, for example in the form of the resistive coil described above, which is provided as part of the aerosol generating article. Electrical connections may enable electric current to flow through the resistive heating element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device configured to heat at least part of an article comprising aerosol generating material, comprising:
a receptacle for receiving at least a portion of the article;
the receptacle comprising a reflecting surface arranged to reflect electromagnetic radiation towards the article;
wherein the reflecting surface has a minimum reflectivity of electromagnetic radiation with a wavelength between 1000 nm and 700 nm of at least 60%.

2. The aerosol provision device of claim 1, comprising a heater.

3. The aerosol provision device of claim 2, wherein the heater is a resistive heating heater.

4. The aerosol provision device of claim 3, wherein the heater comprises a housing and a resistive heating element in the housing.

5. The aerosol provision device of claim 2, wherein the heater protrudes in the receptacle.

6. The aerosol provision device of claim 2, wherein the receptacle comprises a peripheral wall at least partially extending around the heater, and the peripheral wall comprises the reflecting surface.

7. The aerosol provision device of claim 2, wherein the receptacle defines at least a portion of a chamber, and wherein the heater is exposed to the chamber.

8. The aerosol provision device of claim 7, wherein the reflecting surface encircles the chamber.

9. The aerosol provision device of claim 7, wherein the reflecting surface extends over at least 50%, at least 75% or at least 90% of the peripheral extent of the chamber.

10. The aerosol provision device of claim 2, wherein the receptacle comprises a base wall from which the heater upstands.

11. The aerosol provision device of claim 10, wherein the base wall comprises the reflecting surface.

12. The aerosol provision device of claim 1, wherein the reflecting surface is radially evenly distributed with respect to the position occupied by article when received in the receptacle.

13. The aerosol provision device of claim 1, wherein the reflecting surface is arranged such that the amount of radiation reflected by the receptacle varies along a longitudinal extent of the receptacle.

14. The aerosol provision device of claim 13, wherein the receptacle comprises a first longitudinal portion comprising the reflecting surface and a second longitudinal portion free from the reflecting surface.

15. The aerosol provision device of claim 14, wherein the first longitudinal portion comprises at least 50%, at least 75% or at least 90% of the longitudinal extent of the receptacle.

16. The aerosol provision device of claim 1, wherein the reflecting surface comprises a first reflecting surface and a second reflecting surface and wherein the first reflecting surface has a different reflectivity of electromagnetic radiation than the second reflecting surface.

17. The aerosol provision device of claim 1, wherein the reflecting surface comprises a sheet.

18. The aerosol provision device of claim 17, wherein the sheet comprises a foil.

19. The aerosol provision device of claim 1, wherein the reflecting surface comprises a coating.

20. A system comprising the aerosol provision device of claim 1 and an article comprising aerosol generating material.
